(19) United States
(12) Patent Application Publication
(10) Pub. No.: US 2023/0391014 A1
(43) Pub. Date: Dec. 7, 2023

(54) REAL-TIME MULTI-PARAMETER COORDINATING 3D PRINTING AUXILIARY FORMING PROCESS FOR CONTINUOUS FIBER REINFORCED COMPOSITES

(71) Applicant: DALIAN UNIVERSITY OF TECHNOLOGY, Dalian (CN)

(72) Inventors: Rao FU, Dalian (CN); Jianming ZHOU, Dalian (CN); Gongshuo WANG, Dalian (CN); Hongquan WANG, Dalian (CN); Shouyan GUAN, Dalian (CN); Fuji WANG, Dalian (CN)

(21) Appl. No.: 18/303,402

(22) Filed: Apr. 19, 2023

(30) Foreign Application Priority Data
Jun. 7, 2022 (CN) 202210636820.4

(51) Int. Cl. B29C 64/393; B29C 64/165; B33Y 10/00; B33Y 30/00; B33Y 50/02

(52) U.S. Cl. CPC B29C 64/393; B29C 64/165; B33Y 10/00; B33Y 30/00; B33Y 50/02

(57) ABSTRACT

A real-time multi-parameter coordinating 3D printing auxiliary forming process for continuous fiber reinforced composites belongs to the technical field of 3D printing. The method starts an external auxiliary heating mechanism and an external auxiliary pressure mechanism timely according to the characteristics of forming materials, the structure of a forming component and interlayer pressure and temperature differences measured in real time during printing, increases interlayer forming pressure of 3D printing and reduces an interlayer temperature difference to improve interlayer bonding strength of the composites. Meanwhile, the method starts a dedicated auxiliary mechanism accompanying mechanism timely according to an established printing trajectory to ensure that the relative positions of an auxiliary mechanism and a printing device are kept unchanged in real time, to realize sustainable forming of multi-parameter coordinating 3D printing for continuous fiber reinforced composites. The method improves the interlayer bonding quality of the component.

### TECHNICAL FIELD

The present invention belongs to the technical field of 3D printing of fiber reinforced composites, and particularly relates to a real-time multi-parameter coordinating 3D printing auxiliary forming process for continuous fiber reinforced composites.

### BACKGROUND

Additive manufacturing is a forming technology based on the principle of “discretion-accumulation”, also known as “3D” printing, which has high design flexibility and freedom and is suitable for the integrated manufacturing of complex frames. Moreover, forming speed is high and operation is easy. Thus, processing procedures are shortened and processing periods are decreased. It is wildly applied in the fields of aerospace and high-end manufacturing, and receives wide attention in China and abroad as the pillar of the third industrial revolution.

Continuous fiber reinforced thermoplastic composites have the characteristics of light weight, high strength and designable performance, can be combined with the 3D printing technology to realize high-performance integrated manufacturing of complex structural components such as aircraft honeycomb rudders and satellite solar panel truss, and are extremely widely used in military and civilian aspects.

When the thermoplastic composites are under external pressure and heating, the molecular chains of polymers may be diffused between printing layers, thereby achieving fusion and bonding between different printing layers. However, the interlayer bonding strength cannot reach an ideal value in the current 3D printing process of the composites. To solve the problem, numerous scholars carry out extensive exploration in China and abroad. Shan Zhongde et al. have invented an annular coated print head for fiber reinforced composites in a patent with a title of “annular coated print head for fiber reinforced composites”, with patent number CN109551762 A. Fiber and resin are mixed in an impregnation chamber and extruded and formed through an annular coated nozzle. There is a planar structure at the bottom of the nozzle, and the fiber and the resin can be extruded after formed to improve an interlayer bonding effect. However, because the invention mainly focuses on improving the impregnation effect during in-situ impregnation in the print head to improve the forming effect, the design of the print head is greatly changed. Moreover, temperature and pressure acquisition and control devices are added, which have complex structure and are susceptible to external conditions. Xiao Xueliang et al. have invented an invention with a title of “spray head, printer and printing method for continuous fiber reinforced composites”, with patent number CN111497225 A. The invention uses a pressing block located on the spray head and near a nozzle to press a formed surface through a driving device of the pressing block. However, the method cannot ensure that the materials are at appropriate temperature during forming, and only changes the pressure on the printing layers to improve the bonding quality between the printing layers so that the performance improvement of the formed component is limited.

In conclusion, the proposed methods of improving the 3D printing interlayer bonding strength of continuous fiber composites fail to comprehensively consider the control of external temperature and pressure according to the characteristics and performance advantages of the composites, and cannot make the mechanical properties of the printed component reach the ideal value. Therefore, one of the problems to be urgently solved in the field is to propose a real-time multi-parameter coordinating 3D printing auxiliary forming process for continuous fiber reinforced composites.

### SUMMARY

The purpose of the present invention is to propose a real-time multi-parameter coordinating 3D printing auxiliary forming process for continuous fiber reinforced composites to solve the above problems, which not only can ensure the consideration of the external temperature and pressure in the 3D printing process, but also can conduct real-time control through feedback to improve the 3D printing interlayer bonding strength of the continuous fiber reinforced composites.

To achieve the above purpose, the present invention adopts the following technical solution:

A real-time multi-parameter coordinating 3D printing auxiliary forming process for continuous fiber reinforced composites is provided. An external auxiliary heating mechanism and an external auxiliary pressure mechanism are started timely based on physical characteristics of forming materials and requirements of a target component in combination with temperature and pressure during printing, to reduce an interlayer temperature difference and increase interlayer forming pressure to improve interlayer bonding strength of a forming component; meanwhile, an auxiliary mechanism accompanying mechanism is started timely according to an established printing trajectory to ensure that the relative positions of an auxiliary mechanism and a printing device are kept unchanged, to realize sustainable multi-parameter coordinating 3D printing for continuous fiber thermoplastic composites.

Specific steps are as follows:
step 1: obtaining a 3D printing process file (G code) comprising process parameters and forming trajectories according to a 3D printing path planning method of the continuous fiber thermoplastic composites in combination with geometric information and performance requirements of the target component, and importing into a 3D printer;
step 2: determining whether the direction of the printing trajectory is changed during the printing of a layer according to the trajectory information in the 3D printing process file; if so, starting the auxiliary mechanism accompanying mechanism; adjusting the position of the auxiliary mechanism in real time according to the change of the direction of the printing trajectory to control coordination between the movement of the auxiliary mechanism and the change of the printing trajectory so that the relative positions of the auxiliary mechanism and the printing device are kept unchanged, to proceed to step 3; if not, proceeding to step 3 directly;
step 3: determining printing interlayer pressure Fₘ according to printing material properties and the requirements of the target component, and collecting an interlayer pressure signal F₀ during printing; judging whether the height/width ratio of the target component is less than 7; if so, enabling a continuous printing method; if not, enabling a breakpoint printing method; wherein the breakpoints of two adjacent layers are evenly spaced in a vertical direction; for example, the pressure points of the first layer are 1, 3, 5, 7 . . . and the pressure points of the second layer are 2, 4, 6, 8 . . . and so on, wherein the spacing of each point of 1, 2, 3, 4 . . . is the same in the vertical direction to ensure that the interlayer bonding strength is maximized without damaging the target component; formulating and implementing the external auxiliary pressure mechanism in real time;
the external auxiliary pressure mechanism determines the printing interlayer pressure Fₘ according to the printing material properties and the requirements of the target component; if the interlayer pressure F₀ is less than Fₘ during printing, the external auxiliary pressure mechanism is started; if the interlayer pressure is greater than Fₘ during printing, the external auxiliary pressure mechanism is closed; in the process of starting the external auxiliary pressure mechanism, the interlayer pressure value F₀ is measured continuously and real-time feedback is given to control the auxiliary pressure value constant;
when printing resin is PEEK, specific corresponding relationships are shown as follows:
the pressure value in the external auxiliary pressure mechanism comprises the following parameter ranges: the applied pressure value is 0.95(Fₘ−F₀)˜1.05(Fₘ−F₀) when the continuous printing method is used; the applied pressure value is 0.65(Fₘ−F₀)˜0.75(Fₘ−F₀) when the breakpoint printing method is used;
step 4: judging whether a layer to be printed is a first layer in the printing; if so, proceeding to step 6 directly; if not, proceeding to step 5;
step 5: determining a printing interlayer temperature difference Tₘ according to the printing material properties and the requirements of the target component, and formulating and implementing the external auxiliary heating mechanism in real time according to the collected temperature difference signal T₀ between two adjacent printing layers which are laid and newly laid during printing;
In step 5, the external auxiliary heating mechanism: when the printing layer is not the first layer, the distance L₀ between the external auxiliary heating device and the printing layer is collected; a 3D printing external auxiliary heating strategy for continuous fiber reinforced composites is used according to the properties of continuous fibers and resin and the requirements of the target component: if the printing interlayer temperature difference T₀ is greater than Tₘ, the external auxiliary heating mechanism is started; if the printing interlayer temperature difference T₀ is less than Tₘ, the external auxiliary heating mechanism is closed; in the process of starting the external auxiliary heating mechanism, the distance L₀ is measured continuously and real-time feedback is given to control heating power so that auxiliary heating temperature is constant;
The external auxiliary heating mechanism adopts the modes of laser, infrared ray and ultrasonic wave.

Laser auxiliary heating is adopted when forming resin is PEEK, and the specific parameter ranges of the external auxiliary heating mechanism are:
(a) when the temperature difference is 50° C., the heating time is 0.5 s, and the heating distance is 10 cm, external laser auxiliary heating power is 8 W;
(b) when the temperature difference is 53° C., the heating time is 0.4 s, and the heating distance is 14 cm, external laser auxiliary heating power is 9 W;
(c) when the temperature difference is 57° C., the heating time is 0.6 s, and the heating distance is 16 cm, external laser auxiliary heating power is 10 W;
(d) when the temperature difference is 63° C., the heating time is 0.4 s, and the heating distance is 14 cm, external laser auxiliary heating power is 11 W;
the auxiliary mechanism accompanying mechanism, the external auxiliary pressure mechanism and the external auxiliary heating mechanism are all adjusted in real time.

Step 6: judging whether a completed printing layer is a last layer after the printing of the layer; if so, ending the forming; if not, repeating steps 2 to 6 until the target component is printed.

In step 1, the continuous fibers comprise one or combinations of more of continuous basalt fiber, continuous carbon fiber, continuous aramid fiber and continuous glass fiber, and the resin used comprises one or combinations of more of polyamide (PA), polylactic acid (PLA), polyether ether ketone (PEEK) and acrylonitrile-butadiene-styrene plastics (ABS).

Compared with the prior art, the present invention has the following beneficial effects:

The present invention breaks through the previous idea of improving the 3D printing interlayer bonding of continuous fiber reinforced composites basically by optimizing the impregnation process of continuous fiber and resin inside a spray head, gets rid of the defects of difficulty in optimizing the internal temperature distribution in the spray head and easy blockage of the spray head in an optimization process in the traditional technology so that the printing cannot be continued, innovatively proposes the 3D printing technological strategy of continuous fibers with the synergetic assistance of external heating and pressure, realizes the objective of improving the interlayer bonding strength during printing of the component, avoids the complexity of the original technology and the difficulty in operation, reduces the occurrence frequency of failures during printing, improves the printing interlayer bonding strength, and greatly improves the efficiency of production and processing and the mechanical properties of the component.

### DESCRIPTION OF DRAWINGS

FIG. 1 is a flow chart of a real-time multi-parameter coordinating 3D printing auxiliary forming process for continuous fiber reinforced composites in the present invention;

FIG. 2 is a schematic diagram of a printing process in the present invention;

FIG. 3 is a schematic diagram of a breakpoint printing method of the present invention; and

FIG. 4 is a structural schematic diagram of a honeycomb sandwich printed in embodiment 1.

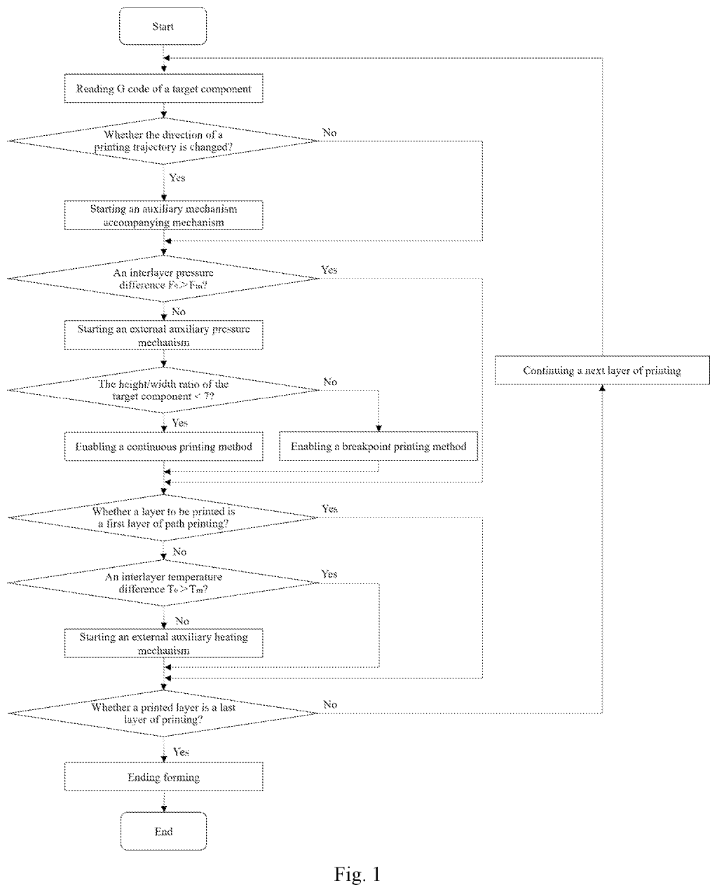

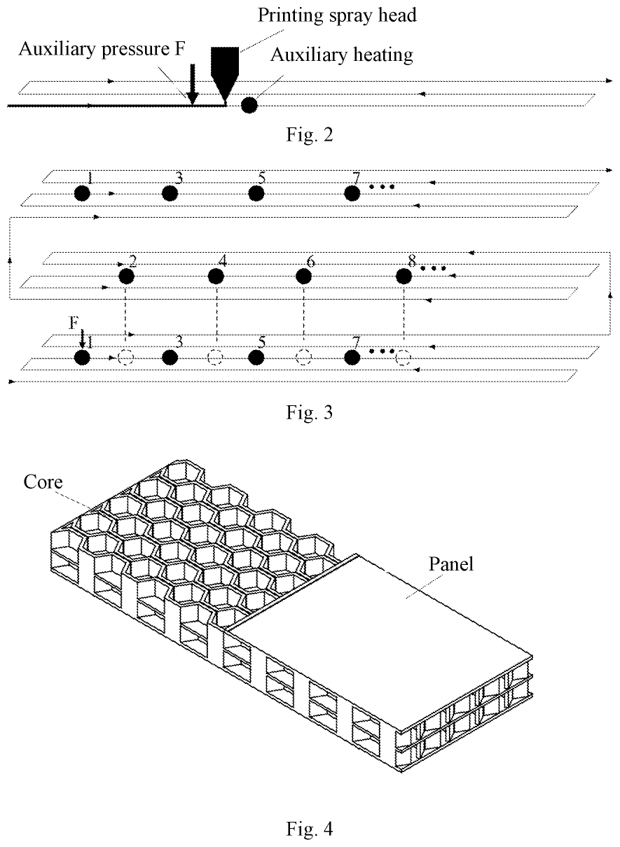

### DETAILED DESCRIPTION

The present invention will be further described in detail below in combination with drawings and embodiments. It should be specially noted that examples and illustration thereof in the present invention are only used for explaining the present invention, not used for limiting the present invention in any aspect.

### Embodiment 1

The present embodiment provides a real-time multi-parameter coordinating 3D printing auxiliary forming process for continuous fiber reinforced composites. A printing method of a component comprises the following specific steps:

(1) Selecting PEEK resin and 1K continuous carbon fiber bundles as raw materials in the present embodiment, to conduct the 3D printing of continuous fiber reinforced thermoplastic composites, wherein a target component is a honeycomb sandwich structure of 300 mm×200 mm×20 mm, with core wall thickness of 1 mm and height of 15 mm; selecting appropriate process parameters to carry out the embodiment according to material characteristics and structural characteristics: bottom plate temperature is 70° C., spray head temperature is 410° C., an interlayer spacing is 1 mm, interlayer thickness is 0.3 mm, and printing speed is 8 mm/s; and obtaining a 3D printing process file (G code) by using dedicated path planning software and importing the file into a dedicated 3D printer.

(2) Determining whether the direction of a printing trajectory is changed during the printing of a layer according to the trajectory information in the 3D printing process file (G code) in (1); if so, starting an auxiliary mechanism accompanying mechanism and forming a movement accompanying strategy of an auxiliary mechanism in real time; synchronously reversing an external auxiliary heating device and an external auxiliary pressure device by using the auxiliary accompanying mechanism, with a reversing angle matched with a reversing angle of the spray head; if not, not executing any mechanism.

(3) Determining appropriate printing interlayer pressure Fₘ of 50N according to the PEEK resin and the 1K continuous carbon fiber bundles selected in (1), and collecting an interlayer pressure signal F₀ during printing; when a panel of a honeycomb sandwich structure is printed, enabling a continuous printing method because the height/width ratio of the component is less than 7, i.e., the external auxiliary pressure needs to be applied continuously on the printing layer; when a core of the honeycomb sandwich structure is printed, enabling a breakpoint printing method because the height/width ratio of the component is greater than 7, i.e., the external auxiliary pressure needs to be applied intermittently on the printing layer, and the breakpoints of two adjacent layers need to be evenly spaced in the vertical direction. For example, the pressure points of the first layer are 1, 3, 5, 7 . . . and the spacing between the adjacent points is 6 mm, and pressure points of the second layer are 2, 4, 6, 8 . . . and the spacing between the adjacent points is also 6 mm, and so on, wherein the spacing of each point of 1, 2, 3, 4 . . . is the same in the vertical direction and the spacing of each point is 3 mm.

When the interlayer pressure F₀ is less than 50N during printing, the external auxiliary pressure mechanism is started; a specific mode is: when the panel of the honeycomb sandwich structure is printed, the continuous printing method is used and the applied pressure value is 0.95(50−F₀)˜1.05(50−F₀); and when the core of the honeycomb sandwich structure is printed, the breakpoint printing method is used and the applied pressure value is 0.65(50−F₀)˜0.75(50−F₀).

When the interlayer pressure F₀ is greater than 50N during printing, the external auxiliary pressure mechanism is closed.

(4) Judging whether a layer to be printed is a first layer in the printing; if so, proceeding to (6) directly; if not, proceeding to (5).

(5) Determining an appropriate printing interlayer temperature difference of 40° C. according to the PEEK resin and the 1K continuous carbon fiber bundles selected in (1); collecting a temperature difference signal between new and old printing layers during printing when the layer to be printed is not the first layer; enabling the external auxiliary heating mechanism if the interlayer temperature difference T₀ is greater than 40° C.; adopting laser auxiliary heating by the mechanism, and measuring a distance L₀ between a laser end and the printing layer to be heated in real time during auxiliary heating, and controlling the heating power by feedback so that the auxiliary heating temperature is constant.

When the interlayer temperature difference is 50° C., the heating time is 0.5 s, and the heating distance is 10 cm, external laser auxiliary heating power is 8 W.

When the interlayer temperature difference T₀ is less than 40° C., the external auxiliary heating mechanism is closed.

(6) Judging whether a completed printing layer is a last layer after the printing of the layer; if so, ending the forming; if not, repeating (2) to (6) until the component is printed.

1. A real-time multi-parameter coordinating 3D printing auxiliary forming process for continuous fiber reinforced composites, wherein an external auxiliary heating mechanism and an external auxiliary pressure mechanism are started timely based on physical characteristics of forming materials and requirements of a target component in combination with temperature and pressure during printing, to reduce an interlayer temperature difference and increase interlayer forming pressure to improve interlayer bonding strength of a forming component; meanwhile, an auxiliary mechanism accompanying mechanism is started timely according to an established printing trajectory to ensure that the relative positions of an auxiliary mechanism and a printing device are kept unchanged, to realize sustainable multi-parameter coordinating 3D printing for continuous fiber thermoplastic composites;
specific steps are as follows:
step 1: obtaining a 3D printing process file comprising process parameters and forming trajectories according to a 3D printing path planning method of the continuous fiber thermoplastic composites in combination with geometric information and performance requirements of the target component, and importing into a 3D printer;
step 2: determining whether the direction of the printing trajectory is changed during the printing of a layer according to the trajectory information in the 3D printing process file; if so, starting the auxiliary mechanism accompanying mechanism; adjusting the position of the auxiliary mechanism in real time according to the change of the direction of the printing trajectory to control coordination between the movement of the auxiliary mechanism and the change of the printing trajectory so that the relative positions of the auxiliary mechanism and the printing device are kept unchanged, to proceed to step 3; if not, proceeding to step 3 directly;
step 3: determining printing interlayer pressure Fₘ according to printing material properties and the requirements of the target component, and collecting an interlayer pressure signal F₀ during printing; judging whether the height/width ratio of the target component is less than 7; if so, enabling a continuous printing method; if not, enabling a breakpoint printing method; ensuring that breakpoints of two adjacent layers are evenly spaced in a vertical direction, and formulating and implementing the external auxiliary pressure mechanism in real time;
step 4: judging whether a layer to be printed is a first layer in the printing; if so, proceeding to step 6 directly; if not, proceeding to step 5;
step 5: determining a printing interlayer temperature difference Tₘ according to the printing material properties and the requirements of the target component, and formulating and implementing the external auxiliary heating mechanism in real time according to the collected temperature difference signal T₀ between two adjacent printing layers which are laid and newly laid during printing;
step 6: judging whether a completed printing layer is a last layer after the printing of the layer; if so, ending the forming; if not, repeating steps 2 to 6 until the target component is printed.

2. The 3D printing auxiliary forming process for continuous fiber reinforced composites according to claim 1, wherein in step 3, the external auxiliary pressure mechanism determines the printing interlayer pressure Fₘ according to the printing material properties and the requirements of the target component; if the interlayer pressure F₀ is less than Fₘ during printing, the external auxiliary pressure mechanism is started; if the interlayer pressure F₀ is greater than Fₘ during printing, the external auxiliary pressure mechanism is closed; in the process of starting the external auxiliary pressure mechanism, the interlayer pressure value F₀ is measured continuously and real-time feedback is given to control the auxiliary pressure value constant.

3. The 3D printing auxiliary forming process for continuous fiber reinforced composites according to claim 2, wherein when printing resin is PEEK, specific corresponding relationships are shown as follows:
the pressure value in the external auxiliary pressure mechanism comprises the following parameter ranges: the applied pressure value is 0.95(Fₘ−F₀)˜1.05(Fₘ−F₀) when the continuous printing method is used; the applied pressure value is 0.65 (Fₘ−F₀)˜0.75(Fₘ−F₀) when the breakpoint printing method is used.

4. The 3D printing auxiliary forming process for continuous fiber reinforced composites according to claim 1, wherein in step 5, the external auxiliary heating mechanism: when the printing layer is not the first layer, the distance L0 between the external auxiliary heating device and the printing layer is collected; a 3D printing external auxiliary heating strategy for continuous fiber reinforced composites is used according to the properties of continuous fibers and resin and the requirements of the target component: if the printing interlayer temperature difference T₀ is greater than Tₘ, the external auxiliary heating mechanism is started; if the printing interlayer temperature difference T₀ is less than Tₘ, the external auxiliary heating mechanism is closed; in the process of starting the external auxiliary heating mechanism, the distance L₀ is measured continuously and real-time feedback is given to control heating power so that auxiliary heating temperature is constant.

5. The 3D printing auxiliary forming process for continuous fiber reinforced composites according to claim 1, wherein the external auxiliary heating mechanism adopts the modes of laser, infrared ray and ultrasonic wave.

6. The 3D printing auxiliary forming process for continuous fiber reinforced composites according to claim 5, wherein laser auxiliary heating is adopted when forming resin is PEEK, and the specific parameter ranges of the external auxiliary heating mechanism are:
(a) when the temperature difference is 50° C., the heating time is 0.5 s, and the heating distance is 10 cm, external laser auxiliary heating power is 8 W;
(b) when the temperature difference is 53° C., the heating time is 0.4 s, and the heating distance is 14 cm, external laser auxiliary heating power is 9 W;
(c) when the temperature difference is 57° C., the heating time is 0.6 s, and the heating distance is 16 cm, external laser auxiliary heating power is 10 W;
(d) when the temperature difference is 63° C., the heating time is 0.4 s, and the heating distance is 14 cm, external laser auxiliary heating power is 11 W;
the auxiliary mechanism accompanying mechanism, the external auxiliary pressure mechanism and the external auxiliary heating mechanism are all adjusted in real time.

7. The 3D printing auxiliary forming process for continuous fiber reinforced composites according to claim 1, wherein the continuous fibers used comprise one or combinations of more than one of continuous basalt fiber, continuous carbon fiber, continuous aramid fiber and continuous glass fiber, and the resin used comprises one or combinations of more than one of polyamide, polylactic acid, polyether ether ketone and acrylonitrile-butadiene-styrene plastics.
